(19) United States
(12) Patent Application Publication
(10) Pub. No.: US 2018/0232808 A1
(43) Pub. Date: Aug. 16, 2018

(54) APPARATUSES, METHODS AND SYSTEMS FOR ELECTRONIC TRADING DISTRIBUTION

(71) Applicant: Thomson Reuters Global Resources Unlimited Company, Baar (CH)

(72) Inventors: Malcolm Melville, Heathfield (GB); Mark Pullan, Harrogate (GB)

(21) Appl. No.: 15/892,604

(22) Filed: Feb. 9, 2018

Related U.S. Application Data
(60) Provisional application No. 62/457,376, filed on Feb. 10, 2017.

(51) Int. Cl. G06Q 40/04

(52) U.S. Cl. CPC G06Q 40/04

(57) ABSTRACT

The present disclosure is directed to methods, systems and programs for electronic trading distribution. An illustrative apparatus includes a memory, and a processor in communication with the memory, and configured to automatically adjust credit allocations associated with each of a plurality of electronic trading systems. The processor executes instructions to receive over network from each respective electronic trading system, electronic trading data associated with the respective electronic trading system, compare the received electronic trading data with predetermined allocation instructions defining credit allocation among the plurality of electronic trading systems, automatically adjust credit allocations to each of the plurality of electronic trading systems based on the comparison of the received electronic trading data with the predetermined allocation instructions, and electronically transmit in real-time over network, the adjusted credit allocations to each of the plurality of electronic trading systems.

This disclosure describes electronic trading distribution methods, apparatuses and media. A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

### PRIORITY CLAIM

This application claims the benefit of priority under 35 USC § 119 to U.S. provisional patent application Ser. No. 62/457,376 filed Feb. 10, 2017, which is hereby expressly incorporated by reference herein for any purpose whatsoever.

### FIELD

The present innovations generally address apparatuses, methods, and systems for electronic trading distribution over a data communications network. However, in order to develop a reader's understanding of the innovations, descriptions have been compiled into a single disclosure to illustrate and clarify how aspects of these innovations operate independently, interoperate as between individual innovations, or cooperate collectively. The application goes on to further describe the interrelations and synergies as between the various innovations; all of which is to further comply with 35 U.S.C. § 112.

### BACKGROUND

In the electronic trading business, credit is often administered to different electronic trading systems. However, these systems can benefit from improvement. The presently disclosed embodiments provide improvements to these kinds of systems.

### SUMMARY

Advantages of the present disclosure will be set forth in and become apparent from the description that follows. Additional advantages of the disclosure will be realized and attained by the methods and systems particularly pointed out in the written description and claims hereof, as well as from the appended drawings.

The present disclosure is directed to an automated, real-time solution for distributing credit amongst disparate electronic trading systems. Many financial exchange systems allow users to initiate transactions. For example, financial exchange systems allow traders to place orders for purchasing a particular stock and the orders are matched and eventually processed. In past financial exchange systems, trades could be initiated and completed over the course of several minutes. Now, most financial exchange systems can initiate and complete transactions within microseconds. Traders today also use multiple, disparate and perhaps unrelated electronic trading systems to initiate trades across different platforms. For example, a trader can initiate a trade across the NASDAQ Stock Exchange while at the same time initiate another trade across the New York Stock Exchange.

In executing these transactions, multiple factors are taken into account before a transaction can be completed. Continuing with the trading example, when executing a trade, a particular trader may have an established credit amount from a particular financial institution. If the trader is only interacting with one financial institution, then the financial institution can determine how to adjust the credit for the trader, should the trader request to exceed the current credit amount. However, distribution of credit is complicated when an entity initiates one or more financial transactions using multiple, unrelated electronic trading systems. These electronic trading systems may not communicate with each other, and in some instances, may require that certain information between the system and the entity remain confidential so that the other competing or nonintegrated system has no knowledge of the details of the relationship between the entity and the initial system. Moreover, if a trader is interacting with several electronic trading systems and trading within a set credit limit across the various trading systems, decomposition of the overall credit position into discrete partitions corresponding to those various trading systems may result in both increased administrative overhead, and the introduction of unnecessary complexity.

Thus, in accordance with some implementations, the disclosure provides systems, methods, and apparatuses for electronic trading distribution over a data communications network. An illustrative apparatus includes a memory, a processor in communication with the memory, and configured to automatically adjust credit allocations associated with each of a plurality of electronic trading systems. The processor executes instructions to receive over network, from each respective electronic trading system, electronic trading data associated with the respective electronic trading system. The received electronic trading data is compared with predetermined allocation instructions defining credit allocation among the plurality of electronic trading systems. The processor is further configured to automatically adjust credit allocations to each of the plurality of electronic trading systems based on the comparison of the received electronic trading data with the predetermined allocation instructions, and electronically transmit in real-time over network, the adjusted credit allocations to each of the plurality of electronic trading systems.

In some implementations, each respective electronic trading system exchanges electronic trading data over network using a different respective communications protocol. In other implementations, the processor executes instructions to dynamically determine at real-time, credit utilization for each respective electronic trading system based on the received electronic trading data and as a function of a global credit allocation shared among the plurality of electronic trading systems. In some implementations, the credit allocations are automatically adjusted at runtime based on the comparison of the received electronic trading data with the predetermined allocation instructions and a global credit allocation shared among the plurality of electronic trading systems. In such implementations, the predetermined allocation instructions include instructions to automatically adjust the credit allocations to each respective electronic trading system based on the occurrence of time triggered events. For instance, the credit allocations to each respective electronic trading system are automatically adjusted based on trading hours, and at least one of sunrise and sunset times in a geographic region associated with the respective electronic trading system. As another example, the credit allocations to each respective electronic trading system may be automatically adjusted based on peak periods of business associated with the respective electronic trading system.

In some implementations, the predetermined allocation instructions include instructions to automatically adjust the credit allocations to each respective electronic trading system based on trading activities in at least one of the electronic trading systems. For instance, the processor may execute instructions to store in the memory, available credit thresholds for each respective electronic trading system relative to a global credit allocation shared among the plurality of electronic trading systems. The predetermined allocation instructions include instructions to automatically adjust the credit allocation to the plurality of electronic trading systems responsive to a determination that the available credit to one of the electronic trading systems met a low available credit threshold. As another illustration, the processor may execute instructions to receive from each respective electronic trading system, the credit utilization and available credit for each respective electronic trading system determined dynamically at real-time. The processor executes instructions to receive over network from a first electronic trading system, a request for a trade, in an amount exceeding the available credit for the first electronic trading system. In some examples, the predetermined allocation instructions include instructions to automatically adjust the credit allocation to the plurality of electronic trading systems responsive to the request from the first electronic trading system.

In some implementations, predetermined allocation instructions include instructions to automatically adjust the credit allocations to each respective electronic trading system based on a predetermined allocation algorithm. For example, the credit allocations to each respective electronic trading system may be automatically adjusted in a weighted manner based on historical electronic trading data received from the electronic trading systems.

In some embodiments, an apparatus includes a memory and a processor in communication with the memory, and configured to automatically adjust credit allocations associated with each of a plurality of electronic trading systems. In such embodiments, the processor may execute instructions to allocate to the plurality of electronic trading systems, portions of a global credit allocation shared among the plurality of electronic trading systems based on predetermined allocation instructions; provide a graphical user interface to each respective electronic trading system including the credit allocated to the respective electronic trading system; receive over network from each respective electronic trading system, electronic trading data associated with the respective electronic trading system; automatically adjust in real-time, the credit allocations to each of the plurality of electronic trading system based on a comparison of the received electronic trading data and the predetermined allocation instructions; and update in real-time, the graphical user interface to include the adjusted credit allocations.

In some implementations, the processor executes instructions to display on a graphical user interface accessible by users of a first electronic trading system among the plurality of electronic trading systems, credit allocations for the first electronic trading system relative to the global credit allocation, and dynamically modify the display accessible by the users of the first electronic trading system to include the adjusted credit allocations for the first electronic trading system.

In various implementations, the processor executes instructions to, in response to a request to adjust the credit allocation for a first electronic trading system, automatically adjust in real-time, the credit allocations of a remainder of the electronic trading systems as a function of the adjusted credit allocation for the first electronic trading system.

In many implementations, the processor executes instructions to electronically transmit in real-time over network, the adjusted credit allocations to one of the electronic trading systems, receive from the electronic trading system, a response to the adjusted credit allocation, and update the graphical user interface for the electronic trading system in response to the received response. In such implementations, the processor may execute instructions to prevent an update to the graphical user interface for the electronic trading system in response to the received response indicating a potential disparity in the credit allocation for the first electronic trading system.

In some embodiments, the processor executes instructions to electronically transmit in real-time over network, to a first electronic trading system and a second electronic trading system, a first request to adjust the credit allocations to the first and second electronic trading systems; to receive from the first and second electronic trading systems, a response to the adjusted credit allocation; and to electronically transmit in real-time over network to the first and second electronic trading systems, a second request to adjust the credit allocations to the first and second electronic trading systems.

The disclosure further provides an electronic trading apparatus including a memory and a processor in communication with the memory, and configured to automatically adjust credit allocations associated with a particular electronic trading system. In such embodiments, the processor executes instructions to receive over network from a service provider communicatively coupled to a plurality of electronic trading systems including the particular electronic trading system, credit allocations for the particular electronic trading system; transmit over network to the service provider, electronic trading data associated with the particular electronic trading system; receive over network from the service provider, a request to adjust the credit allocations for the particular electronic trading system responsive to a comparison of electronic trading data received from the plurality of electronic trading systems and predetermined allocation instructions defining credit allocation among the plurality of electronic trading systems; and provide a response to the service provider, indicating an outcome of the request to adjust the credit allocations for the particular electronic trading system based on a comparison of the request and current electronic trading data associated with the particular electronic trading system.

In some embodiments, the processor executes instructions to electronically transmit in real-time over network, an outcome indicating whether the request to adjust the credit allocations for the particular electronic trading system failed. In the event the request failed, the processor may execute instructions to electronically transmit in real-time over network, an outcome indicating that the request to adjust the credit allocations for the particular electronic trading system breaches credit conditions at the particular electronic trading system. In such embodiments, the processor may execute instructions to receive instructions from the service provider, to adjust the credit allocations for the particular electronic trading system according to the request despite the indication of the breach at the particular electronic trading system.

In some implementations, the processor may execute instructions to electronically transmit in real-time over network, an outcome indicating that the request to adjust the credit allocations for the particular electronic trading system does not breach credit conditions at the particular electronic trading system. In such implementations, the processor executes instructions to receive from the service provider instructions to adjust the credit allocations for the particular electronic trading system according to the request responsive to the indication that the request does not breach credit conditions at the particular electronic trading system.

The disclosure further provides a method of automatically adjusting credit allocations associated with each of a plurality of electronic trading systems via processor. Various implementations of the method include receiving via processor over network from each respective electronic trading system, electronic trading data associated with the respective electronic trading system via processor, comparing via processor the received electronic trading data with predetermined allocation instructions defining credit allocation among the plurality of electronic trading systems, automatically adjusting credit allocations via processor to each of the plurality of electronic trading systems based on the comparison of the received electronic trading data with the predetermined allocation instructions, and electronically transmitting via processor in real-time over network, the adjusted credit allocations to each of the plurality of electronic trading systems.

In some implementations, each respective electronic trading system cab exchange electronic trading data over network using a different respective communications protocol. The electronic trading data can include credit utilization data determined by each respective electronic trading system, and the method can include dynamically determining the credit utilization data for each respective electronic trading system at real-time as a function of a global credit allocation shared among the plurality of electronic trading systems. The method can further include automatically adjusting credit allocations at runtime based on the comparison of the received electronic trading data with the predetermined allocation instructions and a global credit allocation shared among the plurality of electronic trading systems. If desired, the method can further include automatically adjusting the credit allocations to each respective electronic trading system based on occurrence of time triggered events in accordance with the predetermined allocation instructions.

In some implementations of the method, the predetermined allocation instructions can include instructions to automatically adjust the credit allocations to each respective electronic trading system based on at least one of: sunrise and sunset times in a geographic region associated with the respective electronic trading system, trading hours in a geographic region associated with the respective electronic trading system, and peak periods of business associated with the respective electronic trading system. If desired, the method can further include executing instructions to store in memory, available credit thresholds for each respective electronic trading system relative to a global credit allocation shared among the plurality of electronic trading systems. If desired, the method can further include receiving via processor from each respective electronic trading system, credit utilization and available credit for each respective electronic trading system, the credit utilization and available credit for each respective electronic trading system determined dynamically at real-time. The predetermined allocation instructions can include instructions to automatically adjust the credit allocation to the plurality of electronic trading systems responsive to a determination that the available credit to one of the electronic trading systems met a low available credit threshold.

If desired, the method can further include receiving via processor from each respective electronic trading system, credit utilization and available credit for each respective electronic trading system, the credit utilization for each respective electronic trading system determined dynamically at real-time, receiving via processor over network from a first electronic trading system, a request for a trade in an amount exceeding the available credit for the first electronic trading system. If desired, the predetermined allocation instructions can include instructions to automatically adjust the credit allocation to the plurality of electronic trading systems responsive to the request from the first electronic trading system. In other implementations, the predetermined allocation instructions can include instructions to automatically adjust the credit allocations to each respective electronic trading system in a weighted manner based on historical electronic trading data received from the electronic trading systems.

The disclosure can further provide a method of automatically adjusting credit allocations associated with each of a plurality of electronic trading systems via processor. The method can include allocating via processor to the plurality of electronic trading systems, portions of a global credit allocation shared among the plurality of electronic trading systems based on predetermined allocation instructions, providing a graphical user interface via processor to each respective electronic trading system including the credit allocated to the respective electronic trading system, receiving over network via processor from each respective electronic trading system, electronic trading data associated with the respective electronic trading system, automatically adjusting in real-time via processor, the credit allocations to each of the plurality of electronic trading system based on a comparison of the received electronic trading data and the predetermined allocation instructions, and updating in real-time via processor, the graphical user interface to include the adjusted credit allocations.

In various implementations, the method can include displaying via processor on a graphical user interface accessible by users of a first electronic trading system among the plurality of electronic trading systems, credit allocations for the first electronic trading system relative to the global credit allocation, and dynamically modifying via processor the display accessible by the users of the first electronic trading system to include the adjusted credit allocations for the first electronic trading system. If desired, the method can further include, in response to a request to adjust the credit allocation for a first electronic trading system, automatically adjusting via processor in real-time, the credit allocations of a remainder of the electronic trading systems as a function of the adjusted credit allocation for the first electronic trading system. If desired, the method can further include, electronically transmitting via processor in real-time over network, the adjusted credit allocations to one of the electronic trading systems, receiving via processor from the electronic trading system, a response to the adjusted credit allocation, and updating via processor the graphical user interface for the electronic trading system in response to the received response.

In various implementations, the method can include electronically transmitting via processor in real-time over network to a first electronic trading system and a second electronic trading system, a first request to adjust the credit allocations to the first and second electronic trading systems, receiving via processor from the first and second electronic trading systems, a response to the adjusted credit allocation, and electronically transmitting via processor in real-time over network to the first and second electronic trading systems, a second request to adjust the credit allocations to the first and second electronic trading systems. The response from at least one of the first and second electronic trading systems can indicate that conditions at the electronic trading system would be breached by the first request to adjust the credit allocations.

The disclosure still further provides a method of automatically adjusting credit allocations associated with each of a plurality of electronic trading systems via processor. The method can include receiving via processor over network from a service provider communicatively coupled to a plurality of electronic trading systems including the particular electronic trading system, credit allocations for the particular electronic trading system, dynamically determining via processor at real-time, credit utilization for the particular electronic trading system, transmitting via processor over network to the service provider, electronic trading data associated with the particular electronic trading system, including the determined credit utilization, receiving via processor over network from the service provider, a request to adjust the credit allocations for the particular electronic trading system responsive to a comparison of electronic trading data received from the plurality of electronic trading systems and predetermined allocation instructions defining credit allocation among the plurality of electronic trading systems, and providing via processor a response to the service provider, indicating an outcome of the request to adjust the credit allocations for the particular electronic trading system based on a comparison of the request and current electronic trading data associated with the particular electronic trading system.

In various implementations, the method can include electronically transmitting via processor in real-time over network, an outcome indicating that the request to adjust the credit allocations for the particular electronic trading system breaches credit conditions at the particular electronic trading system, and that the request to adjust the credit allocations for the particular electronic trading system failed. The method can include receiving via processor from a service provider instructions to adjust the credit allocations for the particular electronic trading system according to the request despite the indication of a breach at the particular electronic trading system. The method can further include electronically transmitting via processor in real-time over network, an outcome indicating that the request to adjust the credit allocations for the particular electronic trading system does not breach credit conditions at the particular electronic trading system, and receiving via processor from the service provider, instructions to adjust the credit allocations for the particular electronic trading system according to the request and responsive to the indication that the request does not breach credit conditions at the particular electronic trading system.

The disclosure further provides a processor-readable tangible non-transient medium storing a computer program for automatically adjusting credit allocations associated with each of a plurality of electronic trading systems within an electronic trading distribution apparatus, the electronic trading distribution apparatus including a memory and at least one processor in communication with the memory. The computer program includes instructions to receive over network from each respective electronic trading system, electronic trading data associated with the respective electronic trading system, compare the received electronic trading data with predetermined allocation instructions defining credit allocation among the plurality of electronic trading systems, automatically adjust credit allocations to each of the plurality of electronic trading systems based on the comparison of the received electronic trading data with the predetermined allocation instructions, and electronically transmit in real-time over network, the adjusted credit allocations to each of the plurality of electronic trading systems.

In some implementations, the electronic trading data can include credit utilization data determined by each respective electronic trading system, and further wherein the program includes instructions for determining credit utilization data for each respective electronic trading system at real-time as a function of a global credit allocation shared among the plurality of electronic trading systems. If desired, the program can include instructions for automatically adjusting credit allocations at runtime based on the comparison of the received electronic trading data with the predetermined allocation instructions and a global credit allocation shared among the plurality of electronic trading systems. The predetermined allocation instructions can include instructions to automatically adjust the credit allocations to each respective electronic trading system based on occurrence of time triggered events. The predetermined allocation instructions can include instructions to automatically adjust the credit allocations to each respective electronic trading system based on at least one of: sunrise and sunset times in a geographic region associated with the respective electronic trading system, trading hours in a geographic region associated with the respective electronic trading system, and peak periods of business associated with the respective electronic trading system.

In further implementations, the program can further include instructions for storing in the memory, available credit thresholds for each respective electronic trading system relative to a global credit allocation shared among the plurality of electronic trading systems. The program can further include instructions to receive from each respective electronic trading system, credit utilization and available credit for each respective electronic trading system, the credit utilization and available credit for each respective electronic trading system determined dynamically at real-time. The predetermined allocation instructions can include instructions to automatically adjust the credit allocation to the plurality of electronic trading systems responsive to a determination that the available credit to one of the electronic trading systems met a low available credit threshold.

In some implementations, the program can further include instructions to receive from each respective electronic trading system, credit utilization and available credit for each respective electronic trading system, the credit utilization for each respective electronic trading system determined dynamically at real-time, receive over network from a first electronic trading system, a request for a trade in an amount exceeding the available credit for the first electronic trading system. The predetermined allocation instructions can include instructions to automatically adjust the credit allocation to the plurality of electronic trading systems responsive to the request from the first electronic trading system. The predetermined allocation instructions can include instructions to automatically adjust the credit allocations to each respective electronic trading system in a weighted manner based on historical electronic trading data received from the electronic trading systems.

The disclosure further provides a processor-readable tangible non-transient medium storing a computer program for automatically adjusting credit allocations associated with each of a plurality of electronic trading systems within an electronic trading distribution apparatus, the electronic trading distribution apparatus including a memory and at least one processor in communication with the memory. The computer program includes instructions to allocate to the plurality of electronic trading systems, portions of a global credit allocation shared among the plurality of electronic trading systems based on predetermined allocation instructions, provide a graphical user interface to each respective electronic trading system including the credit allocated to the respective electronic trading system, receive over network from each respective electronic trading system, electronic trading data associated with the respective electronic trading system, automatically adjust in real-time, the credit allocations to each of the plurality of electronic trading system based on a comparison of the received electronic trading data and the predetermined allocation instructions; and update in real-time, the graphical user interface to include the adjusted credit allocations.

In some implementations, the program can include instructions to display on a graphical user interface accessible by users of a first electronic trading system among the plurality of electronic trading systems, credit allocations for the first electronic trading system relative to the global credit allocation, and dynamically modify the display accessible by the users of the first electronic trading system to include the adjusted credit allocations for the first electronic trading system. If desired, the program can includes instructions to, in response to a request to adjust the credit allocation for a first electronic trading system, automatically adjust in real-time, the credit allocations of a remainder of the electronic trading systems as a function of the adjusted credit allocation for the first electronic trading system. If desired, the computer program can include instructions to electronically transmit in real-time over network, the adjusted credit allocations to one of the electronic trading systems, receive from the electronic trading system, a response to the adjusted credit allocation, and update the graphical user interface for the electronic trading system in response to the received response.

If desired, the program can include instructions to, electronically transmit in real-time over network to a first electronic trading system and a second electronic trading system, a first request to adjust the credit allocations to the first and second electronic trading systems, receive from the first and second electronic trading systems, a response to the adjusted credit allocation, and electronically transmit in real-time over network to the first and second electronic trading systems, a second request to adjust the credit allocations to the first and second electronic trading systems.

The disclosure further provides a processor-readable tangible non-transient medium storing a computer program for automatically adjusting credit allocations associated with each of a plurality of electronic trading systems within an electronic trading distribution apparatus, the electronic trading distribution apparatus including a memory and at least one processor in communication with the memory. The computer program typically includes instructions to, receive over network from a service provider communicatively coupled to a plurality of electronic trading systems including the particular electronic trading system, credit allocations for the particular electronic trading system, dynamically determine at real-time, credit utilization for the particular electronic trading system, transmit over network to the service provider, electronic trading data associated with the particular electronic trading system, including the determined credit utilization, receive over network from the service provider, a request to adjust the credit allocations for the particular electronic trading system responsive to a comparison of electronic trading data received from the plurality of electronic trading systems and predetermined allocation instructions defining credit allocation among the plurality of electronic trading systems, and provide a response to the service provider, indicating an outcome of the request to adjust the credit allocations for the particular electronic trading system based on a comparison of the request and current electronic trading data associated with the particular electronic trading system.

In some implementations, the program can include instructions to electronically transmit in real-time over network, an outcome indicating that the request to adjust the credit allocations for the particular electronic trading system breaches credit conditions at the particular electronic trading system, and that the request to adjust the credit allocations for the particular electronic trading system failed. If desired, the program can include instructions to receive from a service provider instructions to adjust the credit allocations for the particular electronic trading system according to the request despite the indication of a breach at the particular electronic trading system. If desired, the computer program can include instructions to electronically transmit in real-time over network, an outcome indicating that the request to adjust the credit allocations for the particular electronic trading system does not breach credit conditions at the particular electronic trading system, and receive from the service provider, instructions to adjust the credit allocations for the particular electronic trading system according to the request and responsive to the indication that the request does not breach credit conditions at the particular electronic trading system.

It is to be understood that the foregoing general description and the following detailed description are exemplary and are intended to provide further explanation of the disclosed embodiments. The accompanying drawings, which are incorporated in and constitute part of this specification, are included to illustrate and provide a further understanding of the disclosed methods and systems. Together with the description, the drawings serve to explain principles of the disclosure.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIG. 1 shows an exemplary usage scenario in one embodiment of the present disclosure.

FIG. 2 shows a block diagram illustrating an exemplary architecture in one embodiment of the present disclosure.

FIG. 3 shows a logic and data flow diagram, illustrating aspects of a financial exchange system in one embodiment of the present disclosure.

FIG. 4 shows a logic and data flow diagram, illustrating aspects of a financial exchange system in one embodiment of the present disclosure.

FIG. 5 shows a logic and data flow diagram, illustrating aspects of a financial exchange system in one embodiment of the present disclosure.

FIG. 6 shows a logic and data flow diagram, illustrating aspects of a financial exchange system in one embodiment of the present disclosure.

FIG. 7 shows a block diagram illustrating an exemplary system coordinator in one embodiment of the disclosure.

FIG. 8 shows a block diagram illustrating an exemplary system coordinator in one embodiment of the disclosure.

### DETAILED DESCRIPTION

Reference will now be made in detail to the present preferred embodiments of the disclosure, examples of which are illustrated in the accompanying drawings. The methods and corresponding steps of the disclosed embodiments will be described in conjunction with the detailed description of the system.

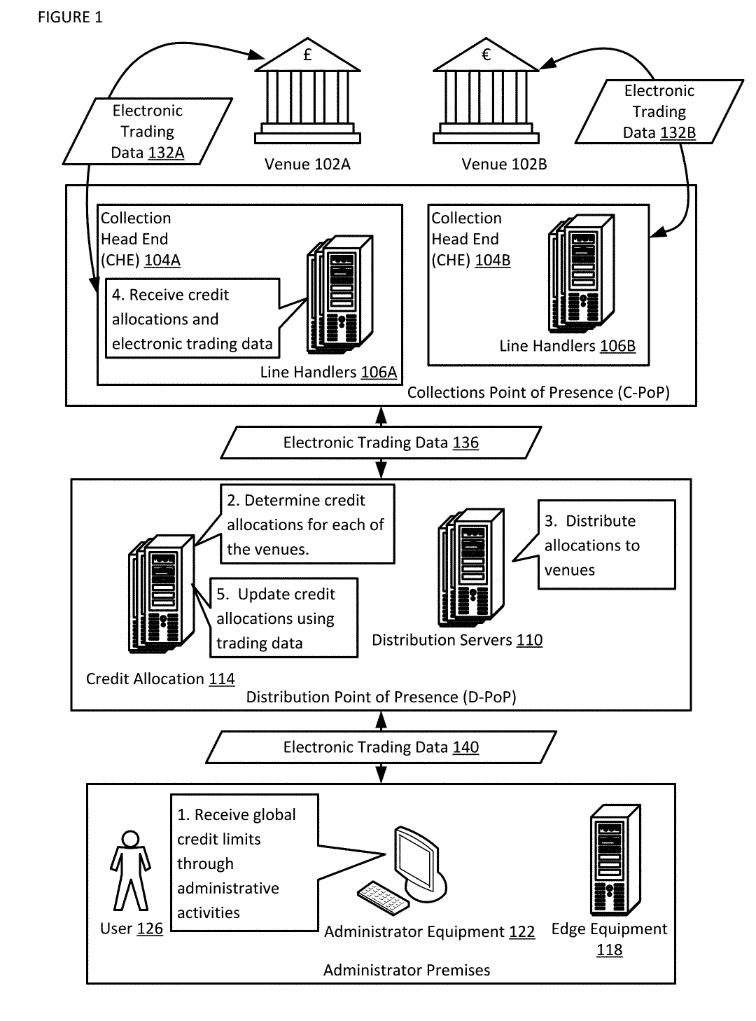

FIG. 1 shows an exemplary usage scenario in one embodiment of the present disclosure. In FIG. 1, electronic trading systems may be associated with different respective venues. For example, venue 102A may be associated with electronic trading system A, whereas venue 102B may be associated with electronic trading system B. In some examples, each respective electronic trading system exchanges electronic trading data over network using a different respective communications protocol. Venues 102A and 102B transmit electronic trading data 132A and 132B, respectively, to collection head ends (CHEs) 104A and 104B, respectively. Electronic trading data includes data associated with controlling trades in a financial exchange system, perhaps between differing electronic trading systems. For example, the electronic trading data may include ask prices, bid prices, volumes, and/or the like for securities traded within the financial exchange system. The CHEs may be a part of a Collections Point of Presence (C-PoP) responsible for ingesting electronic trading data from an associated electronic trading system and providing the content to other components of the financial exchange system. CHE's 104A and 104B may be comprised of one or more line handlers (LHs) 106A and 106B, respectively. Each line handler may be responsible for processing a portion of the electronic trading data provided by the associated electronic trading system. For example, one line handler may be responsible for processing electronic trading data for stocks with identifiers that start with A through C, and another line handler may be responsible for processing electronic trading data for stocks with identifiers that start with D through F. In another example, one line handler may be responsible for processing electronic trading data for one asset class (e.g., stocks), and another line handler may be responsible for processing electronic trading data for another asset class (e.g., bonds).

Electronic trading data 136 may be sent via a network to a Distribution Point of Presence (D-PoP) responsible for distributing electronic trading data in an area. The D-PoP may include distribution servers 110 that distribute electronic trading data to administrators of a financial exchange system. In general, a financial exchange system refers to and/or includes, among other things, a plurality of electronic trading systems communicatively coupled within a data communications network. Administrators of the financial exchange system may facilitate the automatic distribution of credit amongst the plurality of electronic trading systems as described herein. The D-PoP may also include a credit allocation component 114 responsible for setting and adjusting credit allocations for specific electronic trading systems, based on various predetermined allocation instructions.

Electronic trading data 140 may be sent to administrator premises. In one implementation, such data may be sent to edge equipment 118, which may then distribute such data to administrator equipment 122 of a user 126. For example, the administrator equipment may run a trading application that utilizes electronic trading data to facilitate distribution of credit among the electronic trading systems.

A global credit limit may be set centrally through administrative activities. For example, the user 126 may establish a global credit limit, which includes the total amount of funds to be distributed amongst venues 102A and 102B. This global credit limit may be communicated to the D-PoP for allocation amongst the venues. The credit allocation component 114 can determine credit allocations for each of the venues, such that each venue has a fraction of the global credit limit established by the administrator. The D-PoP can distribute the determined credit allocations, via the distribution servers 110, to the various venues. The CHE responsible for each respective electronic trading system may receive from the D-PoP, the distributed credit allocations, indicating the portion of the global credit limit that is allocated to that respective electronic trading system.

For example, the administrator may establish a global credit limit of 15 million dollars ($15M). The D-PoP (e.g., the credit broker) may dynamically determine that venue 102A is allocated 10 million dollars of the 15 million dollar global limit and venue 102B is allocated 5 million of the 15 million dollar global limit. While the dollar is used for purposes of illustration, it is noted that as an example additional and/or different currencies may be used by different electronic trading systems. For example, the system can be implemented using a single type of currency (e.g., US or Australian Dollar) across the entire system across one or more continents. Alternatively, the system can be configured to apply local currencies at each locality, accounting for applicable exchange rates. The D-PoP may determine the credit allocations for each respective electronic trading system (e.g., venue) based on predetermined allocation instructions defining credit allocation among the plurality of electronic trading systems. For example, an administrator may specify a manner in which global credit is to be allocated among the various venues. Examples of methods for distributing global credit may include time-based reallocation events, events based upon trading activity, and/or algorithmic instructions.

The D-PoP, via the credit allocation component 114, may dynamically reallocate credit among the electronic trading systems in a number of ways. For example, the D-PoP may reallocate credit among the electronic trading systems responsive to time-based reallocation events. In such examples, the credit allocation component 114 may execute predetermined allocation instructions to automatically adjust the credit allocations to each respective electronic trading system based on occurrence of time triggered events. For instance, the predetermined allocation instructions may include instructions to automatically adjust the credit allocations to each respective electronic trading system based on sunrise and/or sunset times in a geographic region associated with the respective electronic trading system (e.g., in a “follow-the-sun” methodology). Similarly, the predetermined allocation instructions may include instructions to automatically adjust the credit allocations to each respective electronic trading system based on trading hours in a geographic region associated with the respective electronic trading system (e.g., in an “end-of-day” methodology). In another example, the predetermined allocation instructions may automatically adjust the credit allocations to each respective electronic trading system based on peak periods of business associated with the respective electronic trading system.

Additionally and/or alternatively, the D-PoP may reallocate credit among the electronic trading systems based upon trading activity. In such examples, the credit allocation component 114 may execute predetermined allocation instructions to automatically adjust the credit allocations to each respective electronic trading system based on trading activities in at least one of the electronic trading systems. For instance, based on trading activities at venue 102A, the D-PoP may reallocate credit allocations to both venue 102A and venue 102B.

As an illustration, the credit allocation component 114 may store, in memory, available credit thresholds for each respective electronic trading system relative to a global credit allocation shared among the plurality of electronic trading systems. The credit allocation component 114 may receive electronic trading data 136, including credit utilization and available credit for each of venues 102A and 102B. The credit allocation component 114 may automatically adjust the credit allocations to the electronic trading systems for venues 102A and 102B, responsive to a determination that the available credit to one of the electronic trading systems met a low available credit threshold.

As another illustration, the credit allocation component 114 may receive electronic trading data 136, including credit utilization and available credit for each of venues 102A and 102B, and receive over network from the electronic trading system for venue 102A, a request for a trade in an amount exceeding the available credit for the electronic trading system for venue 102A. The credit allocation component 114 may further execute instructions to automatically adjust the credit allocation to the electronic trading systems for venues 102A and 102B responsive to the request from the electronic trading system for venue 102A.

Furthermore, the D-PoP may reallocate credit among the electronic trading systems based upon a predetermined allocation algorithm. For example, the credit allocation component 114 may execute predetermined allocation instructions to automatically adjust the credit allocations to each respective electronic trading system in a weighted manner based on historical electronic trading data received from the electronic trading systems. Historical trading data from the electronic trading systems for venues 102A and 102B may be collected, and trends corresponding to periods of high trading activity and periods of low trading activity may be identified for each venue. Such historical trading data may be used by the credit allocation component 114 to dynamically adjust credit allocations among the electronic trading systems. For instance, the credit allocation component 114 may execute an algorithm to minimize credit fragmentation across electronic trading systems (e.g., the plurality of venues) when global credit is at, or below, a credit threshold. In another example, the credit allocation component 114 may execute an algorithm to re-balance available credit across venues in response to the occurrence of specified events. In another example, the credit allocation component 114 may execute an algorithm to preemptively concentrate credit allocations in electronic trading systems experiencing high trading activity, and/or to allocate credit in a weighted fashion based upon anticipated or historic trading patterns.

The CHE for each respective venue may determine the utilization for the respective venue, based on trading behavior at that particular venue and independent of any credit administration. That is, each respective venue may execute instructions to dynamically determine at real-time, credit utilization and available credit for each respective electronic trading system based on the electronic trading data at the respective venue, and as a function of a global credit allocation shared among the plurality of electronic trading systems. For example, the electronic trading system for venue 102A may determine the credit utilization for venue 102A based on the electronic trading data 132A for venue 102A. Similarly, the electronic trading system for venue 102B may determine the credit utilization for venue 102B based on the electronic trading data 132B for venue 102B. Based on the credit allocation for the particular venue and the determined credit utilization for the particular venue, the electronic trading system for each respective venue can determine the available credit for electronic trading available to the respective venue. For example, the electronic trading system for venue 102A may determine that venue 102A has a credit allocation of $10M, a credit utilization of $6M and an available credit of $4M. Similarly, the electronic trading system for venue 102B may determine that venue 102B has a credit allocation of $5M, a credit utilization of $3M and an available credit of $2M. The electronic trading data, including the credit utilization and available credit for each respective venue, is communicated with the respective CHEs. For example, the electronic trading data for venue 102A is communicated to CHE 104A, and the electronic trading data for venue 102B is communicated to CHE 104B.

The credit allocation for each of the electronic trading systems may be dynamically modified (e.g., reallocated) based on the electronic trading data received. For instance, CHE 104A may receive electronic trading data from the electronic trading system for venue 102A, and CHE 104B may receive electronic trading data from the electronic trading system for venue 102B. The electronic trading data from each venue may be sent over network to the D-PoP. The D-PoP may, in turn, update credit allocations using the received trading data. To do so, the D-PoP may compare the received electronic trading data with predetermined allocation instructions defining credit allocation among the plurality of electronic trading systems, as described herein. The D-PoP may automatically adjust the credit allocations to each of the electronic trading systems based on the comparison of the received electronic trading data with the predetermined allocation instructions, and electronically transmit in real-time over network, the adjusted credit allocations to each of the electronic trading systems. Accordingly, each of venue 102A and 102B may receive the adjusted credit allocations from the D-PoP.

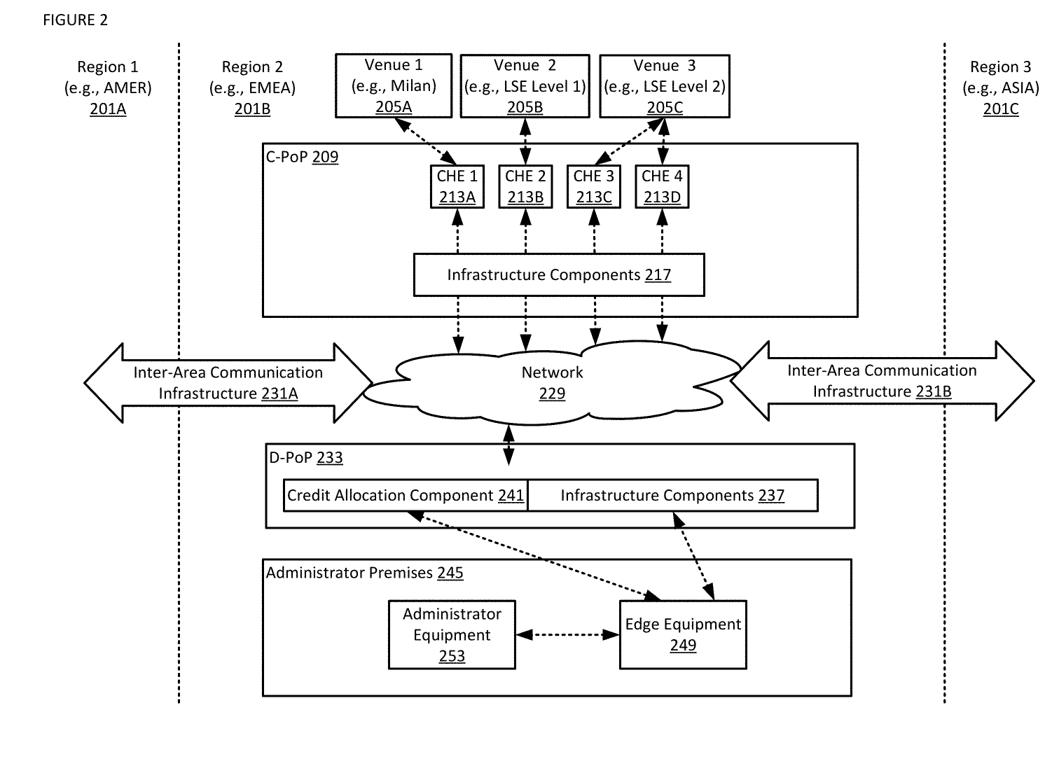

FIG. 2 shows a block diagram illustrating an exemplary financial exchange architecture, in one embodiment of the present disclosure. In FIG. 2, the financial exchange system may span a plurality of geographic regions. For example, region 1 201A may be associated with AMER (Americas), region 2 201B may be associated with EMEA (Europe, Middle East, Africa) and region 3 201C may be associated with Asia.

A region may include one or more venues that provide data feeds or other services to a C-PoP 209 associated with the region. For example, region 2 may include venue 205A that provides a feed of Milan electronic trading data to a CHE 213A, venue 205B that provides a feed of LSE Level 1 electronic trading data to a CHE 213B, and venue 205C that provides a feed of LSE Level 2 electronic trading data to CHEs 213C and 213D. It is to be understood that the financial exchange system may be utilized with any type of content or service provided by a venue. In some embodiments, input feeds from a source (e.g., an electronic trading system such as the LSE) may be treated as different venues. Venues 205A, 205B, and 205C are collectively referred to herein as venues 205.

The CHEs may process the received input feeds via their line handlers and transmit electronic trading data to the D-PoP for communication to an administrator, such as via infrastructure components 217, using a specified message protocol. For example, while each electronic trading system associated with the respective venues 205 may communicate with the C-PoP 209 in different respective communications protocols, the C-PoP may transmit the electronic trading data to the D-PoP 233 via network 229 in a single data stream using a common communications protocol. Accordingly, an administrator may receive electronic trading data from the plurality of venues in one data stream. The infrastructure components 217 may publish their data streams (e.g., including electronic trading data content) to administrators via network 229. Data streams may be passed across regions using inter-area communication infrastructure (e.g., inter-area WAN) 231A (e.g., to send and receive data to and from region 1) and 231B (e.g., to send data to and receive data from region 3).

A D-PoP 233 associated with the region (e.g., one of a plurality of D-PoPs that serve the region) may obtain electronic trading data streams via network 229. Infrastructure components 217 may be used to publish the obtained data to administrators served by the D-PoP. The D-PoP may include a credit allocation component 241 that may determine credit allocations for each respective electronic trading system based on predetermined allocation instructions defining credit allocation among the plurality of electronic trading systems. The credit allocation component 241 may also compare the received electronic trading data with the predetermined allocation instructions, and automatically adjust credit allocations to each of the plurality of electronic trading systems based on the comparison of the received electronic trading data with the predetermined allocation instructions. Additional infrastructure components 237 may electronically transmit in real-time over network 229, the adjusted credit allocations to each of the plurality of electronic trading systems. For example, the distribution servers 110 discussed with regard to FIG. 1 may transmit in real-time over network 229, the adjusted credit allocations to C-PoP 209 for distribution to each of the plurality of electronic trading systems 205.

Administrator premises 245 may include edge equipment 249 and administrator equipment 253 (e.g., workstations used by administrators employed by a customer). The edge equipment may obtain electronic trading data from the D-PoP 233 that serves the administrator premises and provide the electronic trading data to the administrator equipment. For example, the administrator equipment may run a trading application that utilizes electronic trading data to facilitate distribution and redistribution of global credit among the plurality of electronic trading systems.

As described herein, the D-PoP 233 may allocate to the plurality of electronic trading systems, portions of a global credit allocation shared among the venues 205 (e.g., the electronic trading systems associated with each venue) based on predetermined allocation instructions. Similarly, the D-PoP 233 may provide a graphical user interface to each respective electronic trading system including the credit allocated to the respective electronic trading system. For example, the D-PoP 233 may receive over network from each respective electronic trading system 205, electronic trading data associated with the respective electronic trading system. The D-PoP 233 may automatically adjust in real-time, the credit allocations to each of the plurality of electronic trading systems based on a comparison of the received electronic trading data and the predetermined allocation instructions. The D-PoP 233 may in turn, update in real-time, the graphical user interface to include the adjusted credit allocations.

As an illustration, the D-PoP 233 may display on a graphical user interface accessible by users of the electronic trading system associated with venue 205A, credit allocations for venue 205A relative to the global credit allocation. The D-PoP 233 may also dynamically modify the display accessible by such users to include the adjusted credit allocations as they are determined. As another illustration, the D-PoP may, in response to a request to adjust the credit allocation for the electronic trading system associated with venue 205B, automatically adjust in real-time, the credit allocations for the electronic trading systems associated with venues 205A and 205C, respectively. The credit allocations to venues 205A and 205C may be determined as a function of the adjusted credit allocation for venue 205B.

In some examples, the D-PoP 233 may electronically transmit in real-time over network, the adjusted credit allocations to one of the electronic trading systems (such as the electronic trading system associated with venue 205B) and receive from the electronic trading system, a response to the adjusted credit allocation indicating success, partial success, failure, and/or breach of the adjusted credit allocation. The D-PoP may, in turn, update the graphical user interface for the electronic trading system in response to the success, partial success, failure, and/or breach of the adjusted credit allocation. In such an example, the D-PoP may prevent an update to the graphical user interface for the electronic trading system in response to the received response indicating a failure of an adjusted credit allocation. Additionally and/or alternatively, the D-PoP 233 (via the credit allocation component 241) may further adjust the credit allocations based on the response received. For example, the D-PoP 233 may electronically transmit in real-time over network to the electronic trading system associated with venue 205A and the electronic trading system associated with venue 205B, a first request to adjust the credit allocations to the first and second electronic trading systems. The D-PoP 233 may receive from venues 205A and 205B, a response to the adjusted credit allocation. The D-PoP 233 may electronically transmit in real-time over network 229 to venues 205A and 205B, a second request to adjust the credit allocations, if the response from at least one of venues 205A and 205B indicates that conditions at that venue would be breached by the first request to adjust the credit allocations.

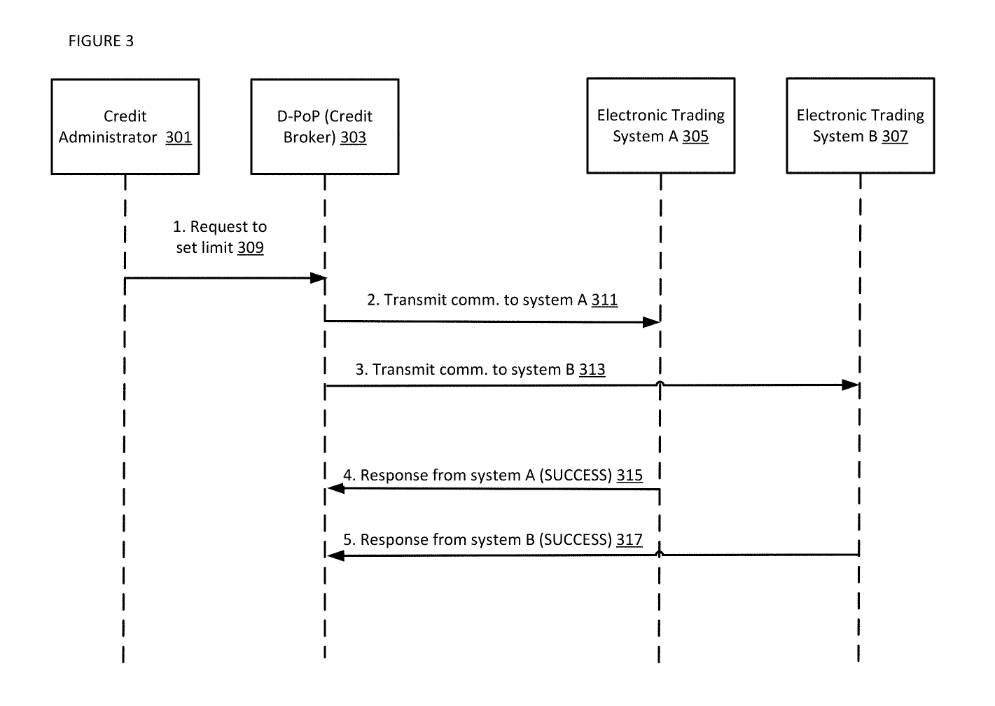

FIG. 3 shows a logic and data flow diagram, illustrating aspects of the financial exchange system in one embodiment of the present disclosure. As illustrated in FIG. 3, the global credit limit may be established by the credit administrator 301 (e.g., via administrator premises 245 illustrated in FIG. 2) with a request to the D-PoP 303 to set credit limits 309 for each of the plurality of electronic trading systems. The D-PoP 303 may, in turn, allocate the global credit among electronic trading system A 305 and electronic trading system B 307 by transmitting communications to each of the electronic trading systems to implement the global credit allocation. As such, the D-PoP 303 may be referred to as a credit broker. The D-PoP 303 may subsequently transmit communications including a request that the electronic trading systems adjust their respective credit allocations with consideration given to available credit at the associated venue, and/or communications including a demand that the electronic trading systems adjust their respective credit allocations irrespective of the available credit at the associated venue.

The D-PoP 303 may subsequently transmit communications 311 and 313 to each of electronic trading systems 305 and 307, the communications including a request to revise or establish credit allocations for the respective electronic trading systems. For example, the credit administrator 301 may establish a global credit limit, such as $10M, and provide the global credit limit to the D-PoP 303. The D-PoP 303 may in turn, send a communication (e.g., a request in this example) to each of the electronic trading systems indicating that each electronic trading system has a credit allocation of $5M. In response to receipt of the communication (e.g., requests 311 and 313), each electronic trading system may send a response (e.g., 315, 317) to the D-PoP 303 indicating a response to the respective request. The response to a request from the D-PoP 303 may indicate success, partial success, and/or failure. A success response indicates that the newly established credit allocation at a particular electronic trading system would not be at an amount less than the credit utilization at that particular electronic trading system. In other words, a success response indicates that the electronic trading system was able to set the limit to the requested value without breaching the new limit value. In contrast, a failure response indicates that the newly established credit allocation at the particular electronic trading system would be at an amount less than the credit utilization at the particular electronic trading system. In other words, a failure response indicates that the electronic trading system did not change the limit as allocation was already at the limit (and thus no change was possible without resulting in a breach condition). A partial success response indicates, for instance, that credit allocation at the particular electronic trading system could be reduced, but not to the amount indicated in the request due to the current credit utilization at the particular electronic trading system. In other words, a partial success response indicates that the electronic trading system was able to reduce the limit, but could not set the limit to the requested value without existing allocation breaching the new limit value. As an illustration, if credit utilization at the venue for electronic trading system A is at $6M, the credit allocation for electronic trading system A is also at $6M, and the D-PoP 303 requests to reduce the credit allocation to electronic trading system A by $4M, the response from electronic trading system A would indicate failure, as the credit allocation could not be reduced. As another illustration, if credit utilization at the venue for electronic trading system A is at $6M, the credit allocation for electronic trading system A is at $8M, and the D-PoP 303 requests to reduce the credit allocation to electronic trading system A by $5M, the response from electronic trading system A would indicate partial success, as the credit allocation could be reduced, but not in an amount as requested by the D-PoP (e.g., electronic trading system A could only reduce credit allocation by $2M, rather than $5M). Similarly, if credit utilization at the venue for electronic trading system A is at $6M, the credit allocation for electronic trading system A is at $10M, and the D-PoP 303 requests to reduce the credit allocation to electronic trading system A by $4M, the response from electronic trading system A would indicate success, as the credit allocation could be reduced by $4M without resulting in the current credit utilization exceeding the credit allocation. A success response indicates that the credit allocation can be implemented without violating credit utilization at the electronic trading system.

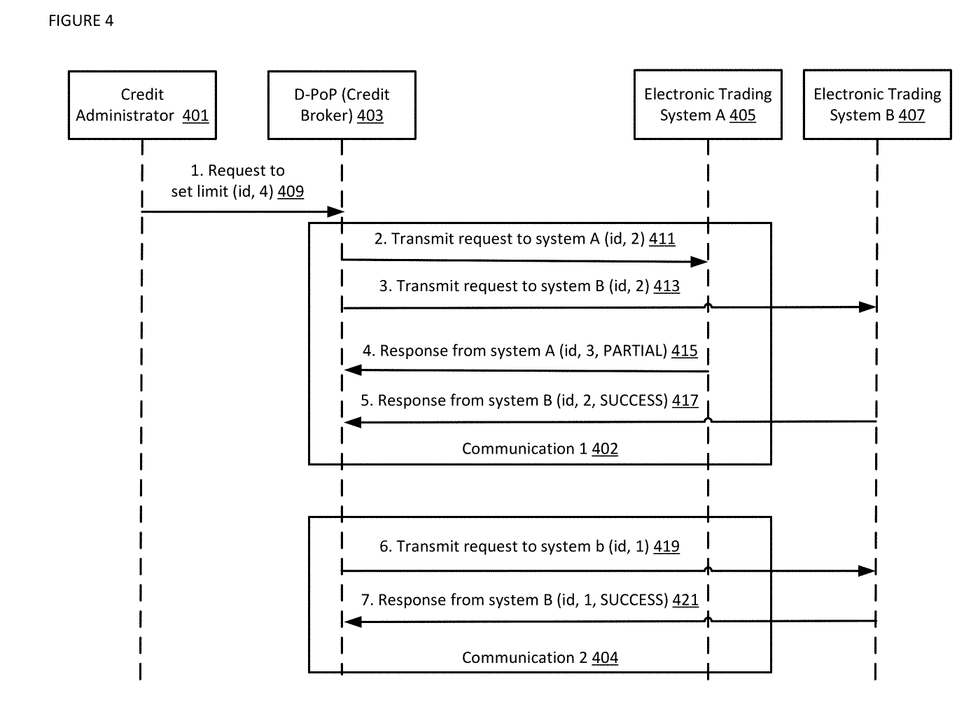

FIG. 4 shows a logic and data flow diagram, illustrating aspects of the financial exchange system in one embodiment of the present disclosure. As illustrated in FIG. 4, the credit administrator 401 may adjust (decrease in this example) the global credit limit, in which case the credit limits for each respective electronic trading system may change. In an example illustrated in FIG. 4, the global credit limit may be reduced by the credit administrator 401 to $4M, but the sum of the credit allocations at each electronic trading system must not exceed the new global credit limit. Accordingly, the D-PoP 403 may submit a first request 402 to reduce credit limits to correspond to the new lower global limit. In this example, the D-PoP 403 may transmit a first communication, including request 411 to electronic trading system A to reduce the credit allocation to electronic trading system A 405 to $2M, and a request 413 to electronic trading system B 407 to reduce the credit allocation to electronic trading system B to $2M. The response 415 from electronic trading system A 405 indicates partial success because the credit allocation to electronic trading system A 405 could be reduced, but not to $2M as requested by the D-PoP 403. In this example, the lowest credit allocation that can be achieved at electronic trading system A 405 based on credit utilization at electronic trading system A is $3M. The response 417 from electronic trading system B 407 indicates success because, based on credit utilization at electronic trading system B 407, the credit allocation at electronic trading system B could be reduced to $2M. Because request 402 was not fully successful (e.g., the request would violate credit conditions at electronic trading system A 405), the D-PoP 403 may submit a second communication 404 to reduce credit limits to correspond to the new lower global limit. The second communication 404 includes a request 419 to electronic trading system B 407 to further reduce the credit available in electronic trading system B 407 so as to comply with the new global credit limit and to avoid breaching credit conditions at electronic trading system A 405. For instance, as the new credit allocation for electronic trading system A 405 is established at $3M (responsive to the first request), the D-PoP 403 may transmit the request 419 to electronic trading system B 407 to establish a credit allocation of $1M for electronic trading system B, such that the combined credit allocation to electronic trading systems A and B is still $4M. In response, electronic trading system B 407 may transmit a response 421 to the D-PoP 403 indicating that the request to establish a credit allocation of $1M was successful.

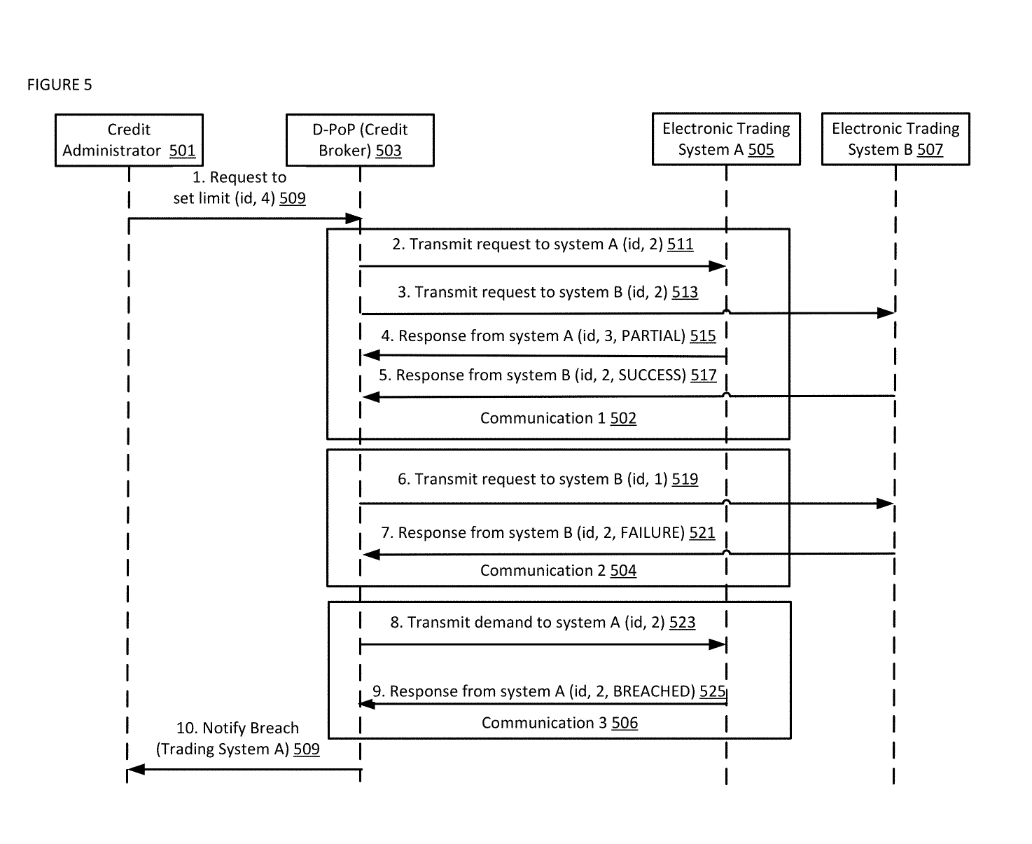

FIG. 5 shows a logic and data flow diagram, illustrating aspects of the financial exchange system in one embodiment of the present disclosure. In this example the global credit limit is reduced by the administrator 501 and the sum of the credit already utilized at each electronic trading system exceeds the new global credit limit. This initially follows the behavior of FIG. 4, but the D-PoP 503 then determines that it cannot reduce the individual credit allocations to the levels required without violating one or more credit conditions. As such, the D-PoP may automatically force (e.g., demand) the electronic trading system to a credit limit that breaches credit conditions. For example, the credit administrator 501 may send a notification 509 to the D-PoP 503 to set the global credit limit at $4M. In response, the D-PoP 503 may send a first communication 502 to each of the electronic trading systems, the first communication including request 511 to electronic trading system A 505 and request 513 to electronic trading system B 507 requesting that they establish credit allocations of $2M. Electronic trading system A 505 may respond at 515 with partial success, because the credit allocation to electronic trading system A 505 can be reduced, but the request to reduce the credit allocation to $2M is below $3M, which is the lowest that could be achieved at electronic trading system A 505 without breaching a credit condition at electronic trading system A 505. That is, the response 515 from electronic trading system A 505 indicates that the credit allocation to electronic trading system could only be reduced to $3M. Put another way, response 515 from electronic trading system A 505 indicates that system A cannot safely set the credit limit for system A at $2M and therefore the limit for electronic trading system A was set at $3M instead. Conversely, the response 517 from electronic trading system B 507 may be successful, indicating that electronic trading system B can reduce its credit limit to $2M without breaching credit conditions. In receiving responses 515 and 517, the D-PoP may send a second communication 504 to electronic trading system B 507. In the second communication 504, the D-PoP may request at 519 that electronic trading system B 507 reduce its credit limit to $1M, thereby permitting electronic trading system A to establish a credit limit of $3M. Electronic trading system B 507 may indicate failure at 521, indicating that such a credit allocation would result in a breach condition at electronic trading system B 507, and the lowest credit allocation that electronic trading system B could implement would be $2M. In this situation, the D-PoP 503 may send a third communication 506 to electronic trading system A, including a demand 523 which forcefully reduces the credit allocation at electronic trading system A 505 to $2M, despite the partial success response 515 previously received from electronic trading system A 505. Electronic trading system A 505 may in turn respond at 525 with a message that indicates that credit conditions at electronic trading system A were breached by the new credit allocation. In response to a demand from the D-PoP 503, the electronic trading systems can respond with a success response indicating that the demand can be implemented without breaching credit conditions at the electronic trading system, or a breach response indicating that the new credit allocation is below the credit utilization at electronic trading system and therefore breaches credit conditions at the electronic trading system. In other words, a breach response indicates that the electronic trading system changed the limit, but this has resulted in a limit breach condition. In response to receipt of the breach message 525, the D-PoP may generate and transmit a notification 509 for credit administrator 501 indicating that there was a breach at electronic trading system A.

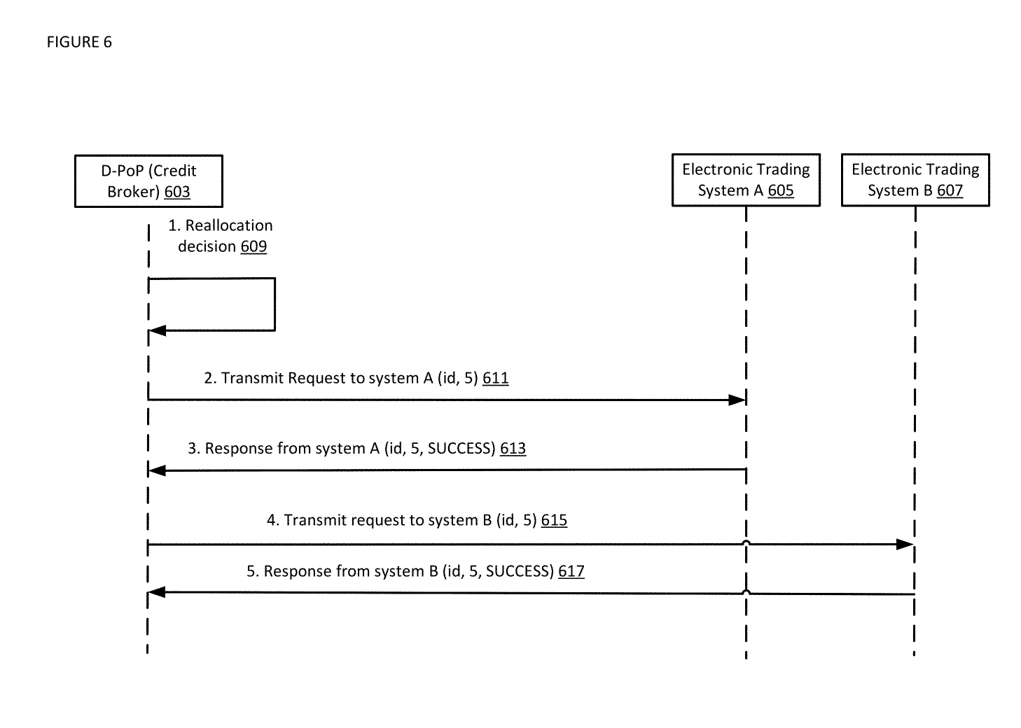

FIG. 6 shows a logic and data flow diagram, illustrating aspects of the financial exchange system in one embodiment of the present disclosure. In this example, the D-PoP 603 may, at 609, reallocate credit among electronic trading systems 605 and 607 based upon its business rules. Unlike previous examples, there is no administrative trigger to this action (e.g., no input from a credit administrator to reallocate credit among the electronic trading systems). In the example of FIG. 6, the sequencing can be relevant, as the D-PoP does not seek to increase the credit available at electronic trading system B 607 until it has first reduced the credit available at electronic trading system A 605. As such, the dynamic reallocation will not result in the breach of a limit at any of the electronic trading systems (and thus precludes a breach of the overall global limit).

For example, the D-PoP 603 may decide to reallocate the $10M in global credit limit among the various electronic trading systems at 609. In response, the D-PoP 603 may transmit a request 611 to electronic trading system A, requesting a credit of $5M (e.g., that electronic trading system A reduce its credit allocation by $5M). In response to a successful response 613 from electronic trading system A, the D-PoP 603 may transmit a request 615 to electronic trading system B, requesting to donate $5M in credit to electronic trading system B. In response to the donate request received from the credit broker (e.g., D-PoP 603), electronic trading system B may respond with a success message 617, indicating that the donation of credit was successful. As such, the D-PoP 603 may automatically reallocate credit among the electronic trading systems without input from a credit administrator. This automatic reallocation may be performed responsive to various criteria. For example, credit may be automatically reallocated responsive to time-based reallocation events, events based upon trading activity, and/or algorithmic instructions, as described herein.

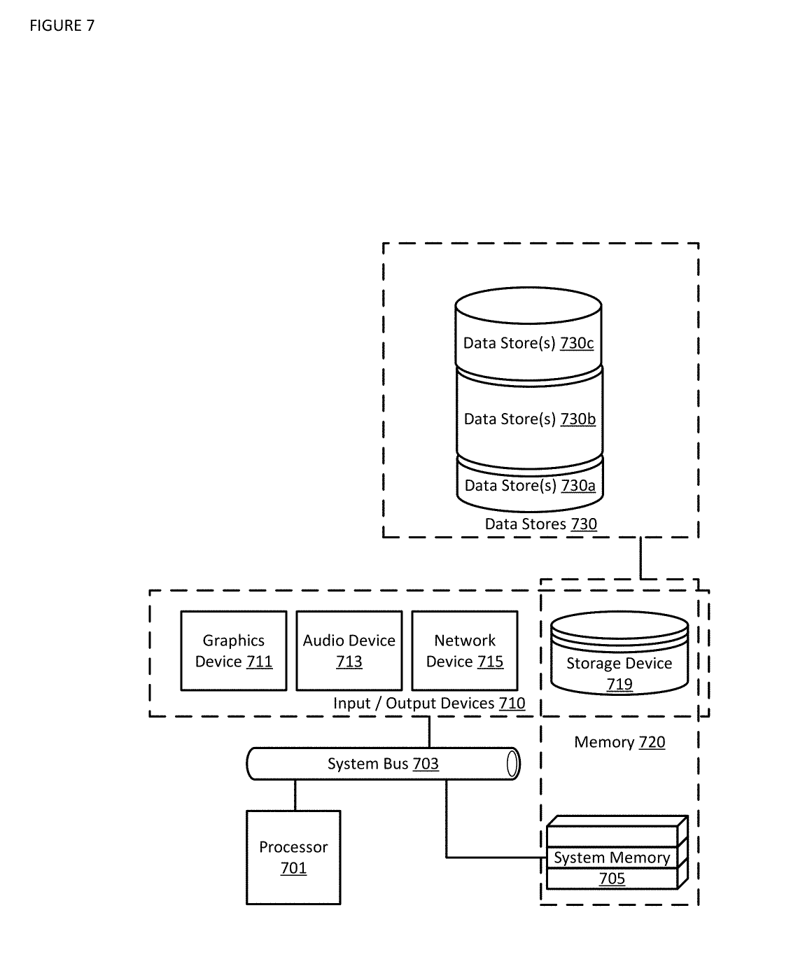

FIG. 7 shows a block diagram illustrating an exemplary financial exchange system coordinator in one embodiment of the disclosure. The financial exchange system coordinator, such as may be implemented on a client side of the financial exchange system. The financial exchange system coordinator facilitates the operation of the financial exchange system via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the financial exchange system coordinator may receive, obtain, aggregate, process, generate, store, retrieve, send, delete, input, output, and/or the like data (including program data and program instructions); may execute program instructions; and may communicate with computer systems, nodes, users, and/or the like. In various embodiments, the financial exchange system coordinator may comprise a standalone computer system, a distributed computer system, a node in a computer network (i.e., a network of computer systems organized in a topology), a network of financial exchange system coordinators, and/or the like. It is to be understood that the financial exchange system coordinator and/or the various financial exchange system coordinator elements (e.g., processor, system bus, memory, input/output devices) may be organized in any number of ways (i.e., using any number and configuration of computer systems, computer networks, nodes, financial exchange system coordinator elements, and/or the like) to facilitate financial exchange system operation. Furthermore, it is to be understood that the various coordinator computer systems, coordinator computer networks, coordinator nodes, coordinator elements, and/or the like may communicate among each other in any number of ways to facilitate financial exchange system operation. As used in this disclosure, the term “administrator” or “user” refers generally to people and/or computer systems that interact with the financial exchange system; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; the term “node” refers generally to a server, to a client, and/or to an intermediary computer system, program, and/or a combination thereof that facilitates transmission of and/or handling of requests and/or responses.

The financial exchange system coordinator includes a processor 701 that executes program instructions (e.g., system program instructions). The processor may be implemented using integrated circuits (ICs), application-specific integrated circuits (ASICs), field-programmable gate arrays (FPGAs), and/or the like. The processor may be connected to system memory 705 via a system bus 703. The system bus may interconnect these and/or other elements of the financial exchange system coordinator via electrical, electronic, optical, wireless, and/or the like communication links In various embodiments, the system bus may comprise one or more control buses, address buses, data buses, memory buses, peripheral buses, and/or the like. The processor may access, read from, write to, store in, erase, modify, and/or the like, the system memory in accordance with program instructions executed by the processor. The system memory may facilitate accessing, storing, retrieving, modifying, deleting, and/or the like data (e.g., financial exchange system data) by the processor.

In various embodiments, input/output devices 710 may be connected to the processor and/or to the system memory, and/or to one another via the system bus. In some embodiments, the input/output devices may include one or more graphics devices 711. The processor may make use of the one or more graphic devices in accordance with program instructions (e.g., system program instructions) executed by the processor. The graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 713. The processor may make use of the one or more audio devices in accordance with program instructions (e.g., system program instructions) executed by the processor. In one implementation, an audio device may be a sound card that may obtain (e.g., via a connected microphone), process, output (e.g., via connected speakers), and/or the like audio data (e.g., system data). The audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 715. The processor may make use of the one or more network devices in accordance with program instructions (e.g., system program instructions) executed by the processor. In one implementation, a network device may be a network card that may obtain, process, output, and/or the like network data (e.g., system data). The network device may be discreet, external, embedded, integrated into a motherboard, and/or the like. The network device may operate in combination with other network devices (e.g., in parallel) to provide improved data throughput, redundancy, and/or the like. In some embodiments, the input/output devices may include one or more storage devices 719. The processor may access, read from, write to, store in, erase, modify, and/or the like a storage device in accordance with program instructions (e.g., system program instructions) executed by the processor. A storage device may facilitate accessing, storing, retrieving, modifying, deleting, and/or the like data (e.g., system data) by the processor. In one implementation, the processor may access data from the storage device directly via the system bus. In another implementation, the processor may access data from the storage device by instructing the storage device to transfer the data to the system memory and accessing the data from the system memory.

The storage device may be discreet, external, embedded, integrated (e.g., into a motherboard, into another storage device), and/or the like. A storage device may operate in combination with other storage devices to provide improved capacity, data throughput, data redundancy, and/or the like. Together and/or separately the system memory 705 and the one or more storage devices 719 may be referred to as memory 720 (i.e., physical memory).

System memory 720 contains processor-operable (e.g., accessible) system data stores 730. Data stores 730 comprise data that may be used (e.g., by the system) via the system coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Data stores 730 may comprise a non-transitory machine readable medium storing instructions executable by processor 701 to perform a specified function. Accordingly, each of the respective data stores 730a-740c include programmatic instructions which, when executed by processor 701, provide for electronic trading distribution in accordance with the present disclosure. For example, data stores 730a-730c may include instructions executable by processor 701 to receive over network from a service provider communicatively coupled to a plurality of electronic trading systems, credit allocations for a particular electronic trading system. As another illustration, data stores 730a-730c may include instructions executable by processor 701 to receive over network from the service provider, a request to adjust the credit allocations, as described herein. Data stores 730a-730c may include instructions executable by processor 701 to provide a response to the service provider, indicating an outcome of the request to adjust the credit allocations, as described with regards to FIGS. 3, 4, 5, and 6.

Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, system coordinator elements, and/or the like) to facilitate system operation. For example, system data stores may comprise data stores 730a-c implemented as one or more databases.

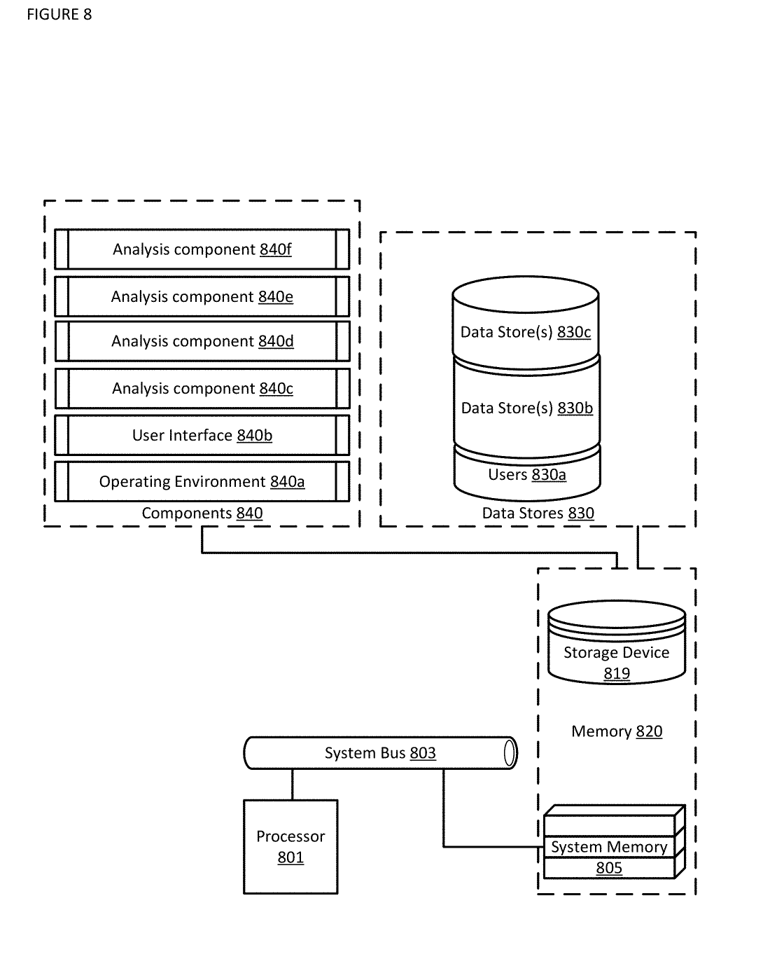

FIG. 8 shows a block diagram illustrating an exemplary financial exchange system coordinator in one embodiment of the disclosure. The financial exchange system coordinator, such as may be implemented by a credit broker, such as by the D-PoP illustrated with regards to FIG. 1. The financial exchange system coordinator facilitates the operation of the financial exchange system via a computer system. In various embodiments, the financial exchange system coordinator may comprise a standalone computer system, a distributed computer system, a node in a computer network (i.e., a network of computer systems organized in a topology), a network of financial exchange system coordinators, and/or the like. It is to be understood that the financial exchange system coordinator and/or the various financial exchange system coordinator elements (e.g., processor, system bus, memory, input/output devices) may be organized in any number of ways (i.e., using any number and configuration of computer systems, computer networks, nodes, financial exchange system coordinator elements, and/or the like) to facilitate financial exchange system operation.

The financial exchange system coordinator includes a processor 801 that executes program instructions (e.g., system program instructions). The processor may be implemented using integrated circuits (ICs), application-specific integrated circuits (ASICs), field-programmable gate arrays (FPGAs), and/or the like. The processor may be connected to system memory 805 via a system bus 803. The system bus may interconnect these and/or other elements of the financial exchange system coordinator via electrical, electronic, optical, wireless, and/or the like communication links. The system memory 805, in various embodiments, may comprise registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions executed by the processor. The system memory may facilitate accessing, storing, retrieving, modifying, deleting, and/or the like data (e.g., financial exchange system data) by the processor.

In some embodiments, the processor may access, read from, write to, store in, erase, modify, and/or the like a storage device 819 in accordance with program instructions (e.g., system program instructions) executed by the processor. A storage device may facilitate accessing, storing, retrieving, modifying, deleting, and/or the like data (e.g., system data) by the processor. In one implementation, the processor may access data from the storage device directly via the system bus. In another implementation, the processor may access data from the storage device by instructing the storage device to transfer the data to the system memory and accessing the data from the system memory. Together and/or separately the system memory 805 and the one or more storage devices 819 may be referred to as memory 820 (i.e., physical memory).

System memory 820 contains processor-operable (e.g., accessible) system data stores 830. Data stores 830 comprise data that may be used (e.g., by the system) via the system coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like.

Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, system coordinator elements, and/or the like) to facilitate system operation. For example, system data stores may comprise data stores 830a-c implemented as one or more databases.

Financial exchange system memory 820 contains processor-operable (e.g., executable) components 840. Components 840 comprise program components (including program instructions and any associated data stores) that are executed (e.g., by the financial exchange system) via the system coordinator (i.e., via the processor) to transform financial exchange system inputs into financial exchange system outputs. It is to be understood that the various components and their subcomponents, capabilities, applications, and/or the like may be organized in any number of ways (i.e., using any number and configuration of components, subcomponents, capabilities, applications, system coordinator elements, and/or the like) to facilitate system operation. Furthermore, it is to be understood that the various components and their subcomponents, capabilities, applications, and/or the like may communicate among each other in any number of ways to facilitate financial exchange system operation. For example, the various components and their subcomponents, capabilities, applications, and/or the like may be combined, integrated, consolidated, split up, distributed, and/or the like in any number of ways to facilitate financial exchange system operation. In another example, a single or multiple instances of the various components and their subcomponents, capabilities, applications, and/or the like may be instantiated on each of a single system coordinator node, across multiple system coordinator nodes, and/or the like.

In some embodiments, components 840 may include an operating environment component 840a. The operating environment component may facilitate operation of the system via various subcomponents. In some implementations, the operating environment component 840a may include an operating system subcomponent. The operating system subcomponent may provide an abstraction layer that facilitates the use of, communication among, common services for, interaction with, security of, and/or the like of various system coordinator elements, components, data stores, and/or the like.

In some embodiments, the operating system subcomponent may facilitate execution of program instructions (e.g., system program instructions) by the processor by providing process management capabilities. For example, the operating system subcomponent may facilitate the use of multiple processors, the execution of multiple processes, multitasking, and/or the like. In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices. In some embodiments, the operating system subcomponent may facilitate operation of the system coordinator as a node in a computer network by providing support for one or more communications protocols.

In some embodiments, the operating system subcomponent may facilitate user interaction with the system by providing user interface elements that may be used by the system to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. In another implementation, such user interface elements may include sounds (e.g., event notification sounds stored in MP3 file format), animations, vibrations, and/or the like that may be used to inform the user regarding occurrence of various events.

In some implementations, the operating environment component may include a database subcomponent. The database subcomponent may facilitate system capabilities such as storage, analysis, retrieval, access, modification, deletion, aggregation, generation, and/or the like of data (e.g., the use of data stores 830). The database subcomponent may make use of database languages (e.g., Structured Query Language (SQL), XQuery), stored procedures, triggers, APIs, and/or the like to provide these capabilities. In various embodiments, the database subcomponent may comprise a cloud database, a data warehouse, a distributed database, an embedded database, a parallel database, a real-time database, and/or the like.

In some implementations, the operating environment component 840a may include an information handling subcomponent. The information handling subcomponent may provide the system with capabilities to serve, deliver, upload, obtain, present, download, and/or the like a variety of information.

In some embodiments, components 840 may include a user interface component 840b. The user interface component may facilitate user interaction with the financial exchange system by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component.

In some embodiments, components 840 may include components 840c-840f capable of analyzing electronic trading data and allocating/reallocating credit among various electronic trading systems, as described herein. Although FIG. 8 illustrates four (4) analysis components, more or fewer analysis components may be included. Components 840 may comprise a non-transitory machine readable medium storing instructions executable by processor 801 to perform a specified function. Accordingly, each of the respective components 840c-840f include programmatic instructions which, when executed by processor 801, provide for electronic trading distribution in accordance with the present disclosure. For example, analysis component 840c may include instructions which, when executed by processor 801, cause processor 801 to receive over network from each respective electronic trading system, electronic trading data associated with the respective electronic trading system. Similarly, analysis component 840d may include instructions which, when executed by processor 801, cause processor 801 to compare the received electronic trading data with predetermined allocation instructions defining credit allocation among the plurality of electronic trading systems. Further, analysis component 840e may include instructions which, when executed by processor 801, cause processor 801 to automatically adjust credit allocations to each of the plurality of electronic trading systems based on the comparison of the received electronic trading data with the predetermined allocation instructions. Analysis component 840f may include instructions which, when executed by processor 801, cause processor 801 to electronically transmit in real-time over network, the adjusted credit allocations to each of the plurality of electronic trading systems.

In some examples, analysis components 840c-840f include instructions executable by processor 801 to receive from each respective electronic trading system, electronic trading data over network using a different respective communications protocol. Moreover, analysis components 840c-840f include instructions executable by processor 801 to automatically adjust credit allocations for each respective electronic trading system at runtime as described herein (e.g., based on predetermined allocation instructions and a global credit allocation).

In some embodiments, analysis components 840c-840f include instructions executable by processor 801 to provide a graphical user interface to each respective electronic trading system including the credit allocated to the respective electronic trading system, and update in real-time the graphical user interface to include adjusted credit allocations, as described herein.

The various components illustrated in FIG. 8 may be capable of performing a method for electronic trading distribution, consistent with the present disclosure. In such examples, the method, executable by processor 801 and memory 820, may include receiving over network from each respective electronic trading system, electronic trading data associated with the respective electronic trading system. Responsive to receipt of the electronic trading data, the method may include comparing the received electronic trading data with predetermined allocation instructions defining credit allocation among the plurality of electronic trading systems. The method may further include automatically adjusting credit allocations to each of the plurality of electronic trading systems based on the comparison of the received electronic trading data with the predetermined allocation instructions. The method may further include electronically transmitting in real-time over network, the adjusted credit allocations to each of the plurality of electronic trading systems.

The entirety of this disclosure (including the written description, figures, claims, abstract, appendices, and/or the like) for ELECTRONIC TRADING DISTRIBUTION shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure.

Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the system coordinator, system coordinator elements, system data stores, system components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the system coordinator, system coordinator elements, system data stores, system components and their subcomponents, capabilities, applications, and/or the like described in various embodiments throughout this disclosure are not limited to serial execution, instead, any number and/or configuration of threads, processes, instances, services, servers, clients, nodes, and/or the like that execute in parallel, concurrently, simultaneously, synchronously, asynchronously, and/or the like is contemplated by this disclosure.

Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, non-provisional applications, continuation applications, continuation-in-part applications, divisional applications, and/or the like. It is to be understood that while some embodiments of the system discussed in this disclosure have been directed to monitoring real time electronic trading data systems, the innovations described in this disclosure may be readily applied to a wide variety of other fields and/or applications.

What is claimed is:

1. An electronic trading distribution apparatus, comprising:
a memory;
a processor in communication with the memory, and configured to automatically adjust credit allocations associated with each of a plurality of electronic trading systems, wherein the processor executes instructions to:
receive over network from each respective electronic trading system, electronic trading data associated with the respective electronic trading system;
compare the received electronic trading data with predetermined allocation instructions defining credit allocation among the plurality of electronic trading systems;
automatically adjust credit allocations to each of the plurality of electronic trading systems based on the comparison of the received electronic trading data with the predetermined allocation instructions; and
electronically transmit in real-time over network, the adjusted credit allocations to each of the plurality of electronic trading systems.

2. The apparatus of claim 1, wherein each respective electronic trading system exchanges electronic trading data over network using a different respective communications protocol.

3. The apparatus of claim 1, wherein the electronic trading data includes credit utilization data determined by each respective electronic trading system, the credit utilization data for each respective electronic trading system determined dynamically at real-time as a function of a global credit allocation shared among the plurality of electronic trading systems.

4. The apparatus of claim 1, wherein the credit allocations are automatically adjusted at runtime based on the comparison of the received electronic trading data with the predetermined allocation instructions and a global credit allocation shared among the plurality of electronic trading systems.

5. The apparatus of claim 1, wherein the predetermined allocation instructions include instructions to automatically adjust the credit allocations to each respective electronic trading system based on occurrence of time triggered events.

6. The apparatus of claim 1, wherein the predetermined allocation instructions include instructions to automatically adjust the credit allocations to each respective electronic trading system based on at least one of: sunrise and sunset times in a geographic region associated with the respective electronic trading system, trading hours in a geographic region associated with the respective electronic trading system, and peak periods of business associated with the respective electronic trading system.

7. The apparatus of claim 1, wherein the processor executes instructions to store in the memory, available credit thresholds for each respective electronic trading system relative to a global credit allocation shared among the plurality of electronic trading systems.

8. The apparatus of claim 7, wherein the processor executes instructions to:
receive from each respective electronic trading system, credit utilization and available credit for each respective electronic trading system, the credit utilization and available credit for each respective electronic trading system determined dynamically at real-time;
wherein the predetermined allocation instructions include instructions to automatically adjust the credit allocation to the plurality of electronic trading systems responsive to a determination that the available credit to one of the electronic trading systems met a low available credit threshold.

9. The apparatus of claim 7, wherein the processor executes instructions to:
receive from each respective electronic trading system, credit utilization and available credit for each respective electronic trading system, the credit utilization for each respective electronic trading system determined dynamically at real-time;
receive over network from a first electronic trading system, a request for a trade in an amount exceeding the available credit for the first electronic trading system; and
wherein the predetermined allocation instructions include instructions to automatically adjust the credit allocation to the plurality of electronic trading systems responsive to the request from the first electronic trading system.

10. The apparatus of claim 1, wherein the predetermined allocation instructions include instructions to automatically adjust the credit allocations to each respective electronic trading system in a weighted manner based on historical electronic trading data received from the electronic trading systems.

11. An electronic trading distribution apparatus, comprising:
a memory;
a processor in communication with the memory, and configured to automatically adjust credit allocations associated with each of a plurality of electronic trading systems, wherein the processor executes instructions to:
allocate to the plurality of electronic trading systems, portions of a global credit allocation shared among the plurality of electronic trading systems based on predetermined allocation instructions;
provide a graphical user interface to each respective electronic trading system including the credit allocated to the respective electronic trading system;
receive over network from each respective electronic trading system, electronic trading data associated with the respective electronic trading system;
automatically adjust in real-time, the credit allocations to each of the plurality of electronic trading system based on a comparison of the received electronic trading data and the predetermined allocation instructions; and
update in real-time, the graphical user interface to include the adjusted credit allocations.

12. The apparatus of claim 11, wherein the processor executes instructions to:
display on a graphical user interface accessible by users of a first electronic trading system among the plurality of electronic trading systems, credit allocations for the first electronic trading system relative to the global credit allocation; and
dynamically modify the display accessible by the users of the first electronic trading system to include the adjusted credit allocations for the first electronic trading system.

13. The apparatus of claim 11, wherein the processor executes instructions to:
in response to a request to adjust the credit allocation for a first electronic trading system, automatically adjust in real-time, the credit allocations of a remainder of the electronic trading systems as a function of the adjusted credit allocation for the first electronic trading system.

14. The apparatus of claim 11, wherein the processor executes instructions to:
electronically transmit in real-time over network, the adjusted credit allocations to one of the electronic trading systems;
receive from the electronic trading system, a response to the adjusted credit allocation; and
update the graphical user interface for the electronic trading system in response to the received response.

15. The apparatus of claim 11, wherein the processor executes instructions to:
electronically transmit in real-time over network to a first electronic trading system and a second electronic trading system, a first request to adjust the credit allocations to the first and second electronic trading systems;
receive from the first and second electronic trading systems, a response to the adjusted credit allocation; and
electronically transmit in real-time over network to the first and second electronic trading systems, a second request to adjust the credit allocations to the first and second electronic trading systems.

16. The apparatus of claim 15, wherein the response from at least one of the first and second electronic trading systems indicates that conditions at the electronic trading system would be breached by the first request to adjust the credit allocations.

17. An electronic trading distribution apparatus, comprising:
a memory;
a processor in communication with the memory, and configured to automatically adjust credit allocations associated with a particular electronic trading system, wherein the processor executes instructions to:
receive over network from a service provider communicatively coupled to a plurality of electronic trading systems including the particular electronic trading system, credit allocations for the particular electronic trading system;
dynamically determine at real-time, credit utilization for the particular electronic trading system;
transmit over network to the service provider, electronic trading data associated with the particular electronic trading system, including the determined credit utilization;
receive over network from the service provider, a request to adjust the credit allocations for the particular electronic trading system responsive to a comparison of electronic trading data received from the plurality of electronic trading systems and predetermined allocation instructions defining credit allocation among the plurality of electronic trading systems; and
provide a response to the service provider, indicating an outcome of the request to adjust the credit allocations for the particular electronic trading system based on a comparison of the request and current electronic trading data associated with the particular electronic trading system.

18. The apparatus of claim 17, wherein the processor executes instructions to electronically transmit in real-time over network, an outcome indicating that the request to adjust the credit allocations for the particular electronic trading system breaches credit conditions at the particular electronic trading system, and that the request to adjust the credit allocations for the particular electronic trading system failed.

19. The apparatus of claim 18, wherein the processor executes instructions to receive from a service provider instructions to adjust the credit allocations for the particular electronic trading system according to the request despite the indication of a breach at the particular electronic trading system.

20. The apparatus of claim 18, wherein the processor executes instructions to:
electronically transmit in real-time over network, an outcome indicating that the request to adjust the credit allocations for the particular electronic trading system does not breach credit conditions at the particular electronic trading system; and
receive from the service provider, instructions to adjust the credit allocations for the particular electronic trading system according to the request and responsive to the indication that the request does not breach credit conditions at the particular electronic trading system.
